(19) United States
(12) Patent Application Publication
(10) Pub. No.: US 2016/0076924 A1
(43) Pub. Date: Mar. 17, 2016

(54) FIELD CYCLING MAGNETIC RESONANCE BASED METHOD AND APPARATUS TO MEASURE AND ANALYZE FLOW PROPERTIES IN FLOWING COMPLEX FLUIDS

(71) Applicants: DANTE ANDRES PUSIOL, ALTA GRACIA (AR); JULIA INES GARCIA, CARLOS PAZ (AR)

(72) Inventors: DANTE ANDRES PUSIOL, ALTA GRACIA (AR); JULIA INES GARCIA, CARLOS PAZ (AR)

(73) Assignee: SPINLOCK SRL, MALAGUENO (AR)

(21) Appl. No.: 14/853,446

(22) Filed: Sep. 14, 2015

Related U.S. Application Data
(60) Provisional application No. 62/051,287, filed on Sep. 16, 2014.

(51) Int. Cl. G01F 1/716; G01N 24/08; G01F 1/74

(52) U.S. Cl. CPC G01F 1/716; G01F 1/74; G01N 24/082

(57) ABSTRACT

Field cycling magnetic resonance based method and apparatus to measure and analyze flow properties in flowing complex fluids. The method consists on: 1) polarizing NMR active spins in a magnetic field region, 2) relaxing the plurality of individual macroscopic magnetizations in a second magnetic field region of variable intensity, 3) measuring the total macroscopic magnetization in a third magnetic field region on an NMR measurement module, and 4) reading the multidimensional data matrix with a tangible computer readable medium. The apparatus consists on: 1) a first magnet with constant magnetic field intensity, 2) a second magnet with a variable magnetic field intensity and time, 3) a third magnet having radio frequency antennas and field gradient coils (NMR module), and 4) a computing digital processor.

### CROSS-REFERENCE TO RELATED APPLICATIONS

This application claims the benefits of Provisional Application 62/051,287 filed Sep. 16, 2014.

### BACKGROUND OF THE INVENTION

1) Field of the Invention

This invention discloses a method and an apparatus for the measurement of the quantity of and the analysis of complex fluids while flowing in a conduit, using Field Cycling Magnetic Resonance (FC-NMR). Without limiting the foregoing, the disclosed invention can be used to distinguish the physicochemical, rheological, and/or flow properties of a fluid. As a possible industrial application, the disclosed invention may be used to measure mixtures of oil, water and gas, production materials, drilling materials, as well as other types of multiphasic fluids.

2) Description of Related Art

The prior art illustrates several methods, based in Nuclear Magnetic Resonance (NMR), to contrast cuts of oil, water and gas while flowing. They are mainly based in the NMR signal intensities contrasted by their respective Spin-Lattice Relaxation Time (T1) at high Larmor frequencies.

As an example, U.S. Pat. No. 6,268,727 B1, “Measurements of flow fractions flow velocities and flow rates of a multiphase fluid using ESR sensing” by J. D. King, et al., illustrates a method and an apparatus which uses a combination of NMR and Electron Spin Resonance (ESR) to measure the fluid multiphase composition and the molecules' “time of flight” between two spectrometers, therefore permitting to measure the velocity of each phase. The referenced patent necessarily requires the mixture of phases to be homogeneously distributed among the fluid. This requirement implies that the referenced invention has a serious practical limitation in the Oil & Gas Industry applications, this because homogeneity is hardly ever reached in the field.

U.S. Pat No. 6,452,390 “Magnetic Resonance analyzing flow meter and flow measuring method” by E. Wollin, employs periodic magnetic field gradients to modulate the spin protons so as to measure the mean velocity or map flow velocity in non-uniform velocity profile. The limitation of this invention relates to it being restricted to measure monophasic fluid, only.

The U.S. Pat No. 7,719,267, “Apparatus and method for real time and real flow-rates measurements of oil and water cuts from oil production”, by D. J. Pusiol and the U.S. Pat No. 7,872,474, “Magnetic resonance based apparatus and method to analyze and to measure the bi-directional flow regime in a transport or a production conduit of complex fluids, in real time and real flow-rate”, by D. J. Pusiol, et al., disclose methods and apparatus for multiphase flow measurements and single phase flow regime characterization, including in-pipe Magnetic Resonance Imaging.

Both cited patents disclose apparatus having two sections: a pre-polarization segment having variable effective length, and a measurement section. The contrast between phases is therein reached by the effect of the pre-polarization section of the apparatus. When the polarizing segment is set to the longest possible, all proton nuclei of the fluid will be polarized and the NMR signal strength will represent the entire set of protons in the fluid. When the pre-polarization segment is reduced, fast polarizing nuclei, corresponding to the phase having short T1, will reach full polarization. Therefore, the obtained NMR signal will mainly represent the content of that single phase. The disclosed invention differs from the previously cited patents mainly because such cited patents, as explained, obtain contrast through the use of the valiable effective length preporalization section, whereas the disclosed invention obtains an even enhanced contrast using the Field Cycling together with a variable intermediate magnetic field, as will be further disclosed below.

The U.S. Pat No. 6,479,994 B1 “Industrial on-line analysis by nuclear magnetic resonance spectroscopy”, by B. P. Hills and K. M. Wright, illustrate a magnetic resonance spectroscopic methodology and apparatus for chemical analysis of objects in a conveyor passing through an NMR detector module. The objects are passed at a predetermined constant velocity. The inventors do not claim the use of the Spectroscopic Methodology to measure flow properties, i.e., multiphasic flow-rates, local velocity profiles, rheological properties, etc. The cited patent does not claim the use of Field Cycling technology. Furthermore, in Claim 1 it is claimed a predetermined velocity at which an object is analyzed through the NMR module therein, it also claims a constant magnetic field B0 substantially parallel to the direction of the velocity, and finally it claims using a coil that generates a field with a component perpendicular to the coil which is at the same time also perpendicular to the velocity. The last three claimed elements are substantially different from the disclosed invention, where it contains no such predetermined velocity, whereas the magnetic field of the NMR module is not parallel but perpendicular to the velocity (flow) and finally whereas the field generated by RF coils is parallel and not perpendicular to the velocity (flow).

The U.S. Pat No. 6,583,622 by B. P. Hills, “NMR Field Cycling Spectrometer in which the sample is conveyed on a circular path at a predetermined angular velocity”. The invented method and its respective apparatus comprises two steps: i) the object under analysis rotates at a first predetermined constant velocity about the center of a circumference, so that the object is repetitively conveyed along a circular path. Along that circular path sequentially passes through a first constant field strength magnet and a second magnet having a second constant field strength; ii) Magnetic Resonance signals are detected when the sample is passing through the second magnetic field region. The sample, which is an object circulating several times at a predetermined angular velocity, passes through the two magnets array. In each cycle the spins of the object senses a temporal variation on the Zeeman magnetic field, which is used to both weight and detect de magnetic resonance signals.

The invention described herein differs fundamentally from previous approaches. Previous Art Field Cycling NMR measurements are performed in a stationary sample, or in a sample undergoing steady circular motion, or when the sample is mechanically moved from a first magnet to a second one, but never just flowing, whether in a simple linear or another more complex conduit, and where the NMR parameters can be measured only once.

The present invention discloses a Field Cycling NMR method and apparatus that can be applied in flowing samples, where the spectroscopy, relaxometry and diffusometry properties are measured, even when the individual component velocities are not steady.

In addition, the present invention differs from the prior art NMR Flow Meters because the measurements are performed in three stages, when previously only two stages were applicable. Herein stage first and second are for reaching contrast of the individual phases magnetic resonance signals, and stage three is the NMR measurement of the flowing sample, as it is disclosed in detail below. In stage first, the entire sample protons are polarized; in stage second the sample is submitted to a magnetic field so the individual phase mechanisms are more effective; and in stage third the sample is passed through a NMR or ESR or double NMR-ESR measurement section.

### BRIEF SUMMARY OF THE INVENTION

According to one aspect, the present invention discloses a method and an apparatus to measure flow properties of multi component complex fluids, based on Field Cycling Magnetic Resonance (FC-MR), comprising a first prepolarization module having a magnet with a first magnetic field, a second contrast module having a magnet with a variable magnetic field strength, a third module having a magnetic resonance measurement module and a control computer.

According to a further aspect, the present invention also discloses an apparatus based on Field Cycling Magnetic Resonance to measure and analyze flow properties in flowing multiphasic complex fluids, wherein the first magnet creates a first magnetic field region with a constant magnetic field intensity, wherein the multiphasic complex fluid flows through the first magnetic field region, and wherein in the first magnetic field region a plurality of NMR active spins of the multiphasic complex fluid are polarized. It further comprises a second magnet module, wherein the second magnet creates a second magnetic field region, wherein the second magnetic field region is variable in magnetic field intensity and time, and wherein in the variable magnetic field region a plurality of spins of the multiphasic complex fluid relax; an third module comprising a third magnet, a plurality of radio-frequency antennas and a plurality of magnetic field gradient coils, wherein the third magnet creates a third magnetic field region with a constant magnetic field intensity, wherein the fluid passes through the third magnetic field region, wherein the radio-frequency antennas create an electromagnetic excitation field applying a plurality of radio frequency pulses, wherein the fluid passes through the electromagnetic excitation field, and wherein the radio-frequency antenna receives a magnetic resonance signal response originated in the multiphasic complex fluid; wherein the magnetic field gradient coils create a plurality of variable local magnetic fields, wherein the fluid passes through the plurality of variable local magnetic fields, wherein the plurality of spins of the multiphasic complex fluid are spatially encoded; a fourth module, the fourth module comprising a computing digital processor, configured to read a tangible computer-readable medium having stored thereon instructions that when read by a processor enable the processor to execute said method, control NMR Field Cycling apparatus elements to execute automatic experimental measurements and display experimental results.

### BRIEF DESCRIPTION OF DRAWINGS

The present disclosure is best understood with reference to the following figures in which like numerals refer to like elements, and in which:

FIG. 1: Illustrates on a schematic representation of a typical cycle of the magnetic field B0 in three periods and intensities: Polatrization magnetic field, Bp, Relaxation magnetic field Br, NMR sensor magnetic field Bd, the radiofrequency excitation field B1 and the Free Induction Decay-NMR signal, in a Field-Cycling NMR Relaxometry typical experiment.

FIG. 2: Illustrates on the NMR field cycling measurements of T1-relaxation profiles on, respectively, three phases: gas 20, brine 21, light oil 22 and heavy oil 23. Spin-lattice relaxation dispersion profiles by conventional 24, electronically switched field cycling 25, are compared as well.

FIG. 3a: Illustrate on a general schematic representation of a Field Cycling Magnetic Resonance Multiphase Flow Meter/Analyzer apparatus and methods.

FIG. 3b: Illustrate on a preferred embodiment of a Field Cycling Magnetic Resonance Multiphase Flow Meter/Analyzer apparatus, including a plurality of modules and sub-modules.

FIG. 4: Illustrate on a one preferred embodiment of the invention: a Triphasic (Oil+Gas+Water) Flow Meter. The three modules of the apparatus possessing differentiated magnetic field zones are illustrated: i) a first pre-polarization permanent magnet 40; ii) a second variable intensity magnet, where the sample magnetization reaches a certain contrast under a variable low magnetic field; and iii) a third module, the NMR-module, including the respective high homogeneity magnetic field, wherein the NMR parameters are measured.

FIG. 5: Illustrates on a preferred embodiment of the pre-polarization permanent magnet.

FIG. 6: Illustrates one embodiment for the relaxation module where the relaxation magnetic field is perpendicular to the flow direction and it is provided by a pulsed electromagnet.

FIG. 7: Illustrates on a Halbach design permanent magnet, including magnetic parts temperature control, temperature drift magnetic field compensation device.

FIG. 8: Illustrate on magnetization evolution for both brine 81 and light oil samples 80 adopting T1( )-relaxation profile data from FIG. 2 and real magnet dimensions provided for the device illustrated in FIG. 4.

FIG. 9: Illustrate on experimental measurement of signal intensity of a brine sample vs. flow rate, carried-on with the flow meter descripted in FIG. 4, in a multiphasic flow meter, in two situations: the relaxation magnetic field is settled on 91; and the relaxation magnetic field is settled off 92.

FIG. 10: Illustrate on experimental measurements of flow rate by the Field Cycling NMR Flow Meter shown in the FIG. 4 vs. the Flow Loop Flow Rate.

Further features and applications of the present invention will become readily apparent from the figures and detailed description that follows.

### DETAILED DESCRIPTION OF THE INVENTION

Relaxation of protons of molecules composing any material, and in particular a fluid, is driven by modulations of the dipolar proton-proton coupling. Dipolar proton-proton coupling is modulated by molecular dynamics. In other words, the magnetic dipolar energy stored in the sample's proton nuclei will discharge to the lattice following relaxation mechanisms provided by, respectively, the different molecular motions of molecules.

Field-cycling NMR relaxometry [see F. Noack, Prog. Nucl. Magn. Reson. Spectrosc. 18 (1986) 171.], is the preferred technique for obtaining the frequency (or magnetic field) dependence of relaxation times (or equivalently of relaxation rates). It is therefore also referred to as Nuclear Magnetic Relaxation Dispersion (NMRD). The term “relaxometry” is normally used in the context of measurements of spin-lattice relaxation times in general. Transverse Relaxation and effects due to residual dipolar coupling (see R. Kimmich, NMR Tomography, Diffusometry, Relaxometry, Springer, Berlin, 1997, for instance) can also be employed as a source of useful supplementary information.

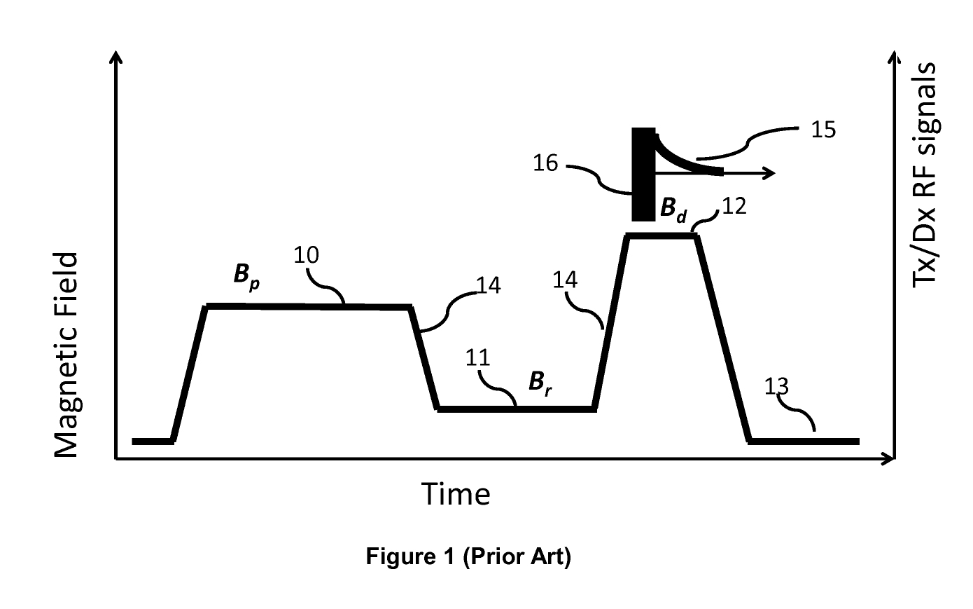

The principle of a typical field-cycling NMR relaxometry experiment is illustrated on FIG. 1 of the prior art. In the first magnetic field 10 with a high magnetic flux density Bₚ, an equilibrium magnetization of the sample is built-up. After switching down to the relaxation field Bᵣ in the second interval 11, the spin system relaxes to a new equilibrium imposed by the new magnetic field value. The switching procedure must be implemented taking care to fulfill the adiabatic demagnetization condition (as explained by A. Abragam, in “The Principles of Nuclear Magnetism”, Clarendon Press, Oxford, 1961). Finally the magnetic field is adiabatically switched to the detection magnetic field of a fixed flux density B_{d} 12. That is, signals are acquired after the excitation the sample spins with adequate radio frequency pulses sequences (RF), provided by a RF unit tuned to a predetermined frequency, irrespective of the settled relaxation field 21. Then an extended recycle delay for the restoration of thermal equilibrium and polarization follows until the next cycle begins. Magnetic fields switching off and on 14, should be done enough fast to retain intact the magnetization information on each time interval of the experiment. If it is too slow T1 relaxation takes place in the transition and, contrarily, if it is to fast, thethe “adiabatic demagnetization” condition is not fulfilled. The effect on the magnetization at the signal acquiring time, in both situations, is the same: the partial or total destruction of the magnetization.

The temporal exposure of the sample to a variable relaxation magnetic field, as illustrated in the FIG. 1, in the previous art is performed either by electronically switching the current in a magnet coil (see, F. Noack, Prog. Nucl. Magn. Reson. Spectrosc. 18 (1986) 171) or by moving the sample mechanically, normally pneumatically, between positions of different magnetic flux densities (see D. P. Weitekamp, A. Bielecki, D. Zax, K. Zilm, A. Pines, Phys. Rev. Lett. 50 (1983) 1807). The latter field-cycling variant is also referred to as “sample shuttle technique”. Field Cycling Magnetic Resonance has been recently reviewed by R. Kimmich, E. Anoardo, Progress in Nuclear Magnetic Resonance Spectroscopy 44 (2004) 257-320 317.

### Disclosed Invention

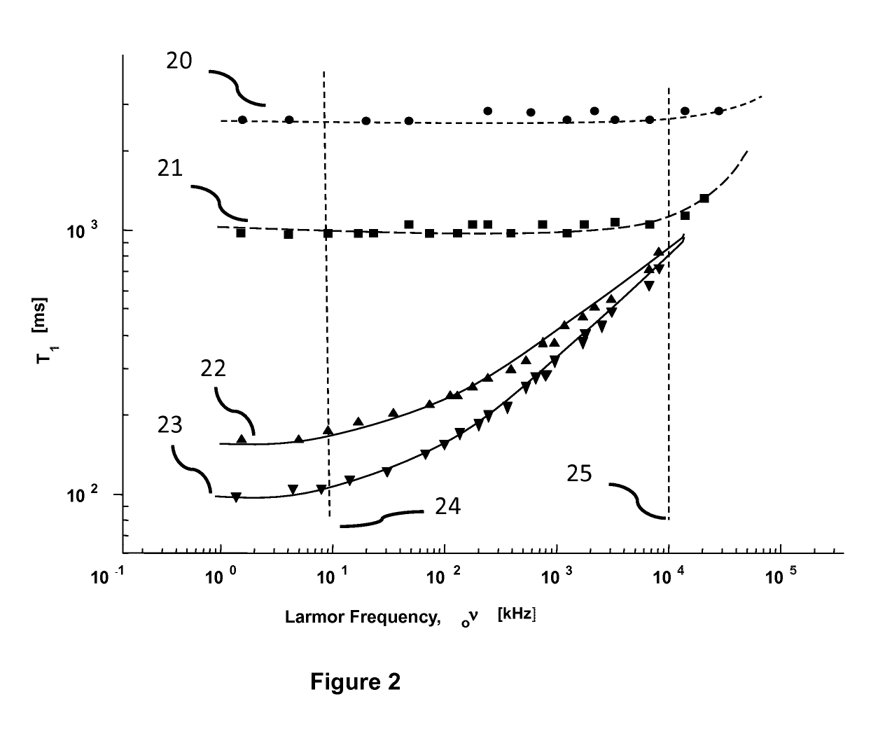

The key study, which supports the present invention, is illustrated in FIG. 2. Field Cycling NMR measurements of the T₁( )-relaxation profiles at magnetic fields, corresponding to protons, within the Larmor frequency range from 2 Khz to 10 MHz, were performed using a conventional, electronically switched, Field Cycling NMR Relaxometer in static samples. Material samples and principal experimental conditions are: methane gas at 300 psi 20, brine 21, light oil 22 and a medium viscosity oil 23, all data are acquired at room temperature (24° C.). From present T₁( ) measurements, it is concluded that T₁( )-based contrast for oil/water/gas cuts produced through spin-lattice relaxation mechanisms in the time scale corresponding to Larmor frequencies in the kHz range 24 is significantly more effective than the contrast acquired at the about 10 MHz range 25, as used in the prior art.

The explanation of the measured behaviors is principally based on respective molecular mobility in each of the phases:
1) Gas: due to the high mobility of molecules in this phase, the Larmor frequency relaxation rate is principally governed by isotropic internal rotations and self-diffusion. Variations of the T₁( ) values depend on the gas pressure and temperature.
2) Water: Pure water behaves similarly to gas, but due to its comparatively higher viscosity, T₁( ) acquires smaller values than those of the gas phase. For salty water (brine), an extra relaxation mechanism appears modulating the proton-proton dipolar coupling; namely, the exchange between bulk and solvation water molecules. In particular, gas, brine and water's T₁( ) profiles behaves practically constant at the low range Larmor frequency.
3) Oil: Complex and long hydro-carbonated chains also generate a band of expected T₁( ), but in this case the Larmor frequency relaxation dispersion is essentially driven by local intermolecular fluctuation and/or molecular reorientation mediated by diffusion mechanisms. Longer oil molecules, associated to higher viscosities, are reflected in a higher T₁ ( )-drop at low relaxation magnetic fields.

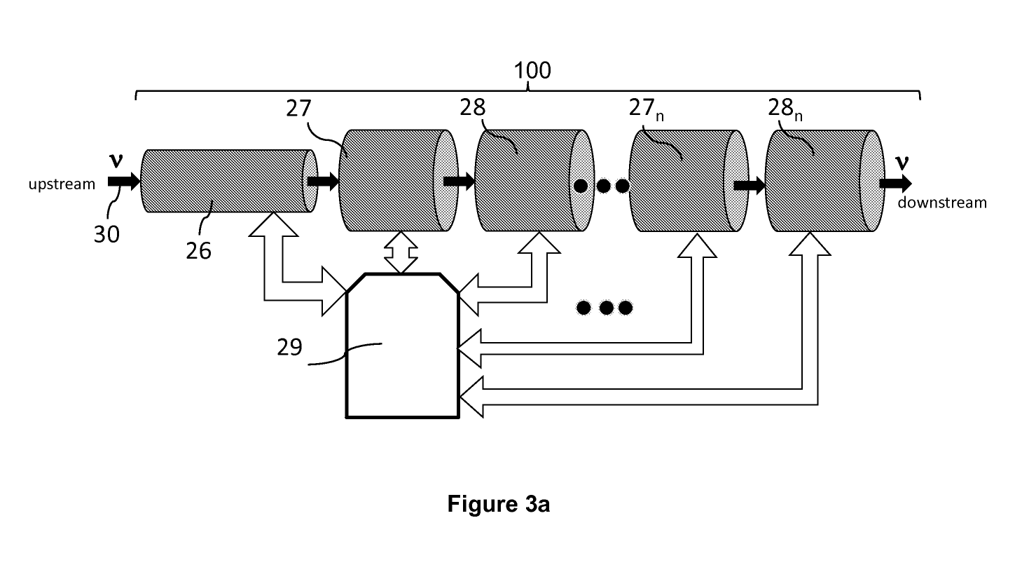

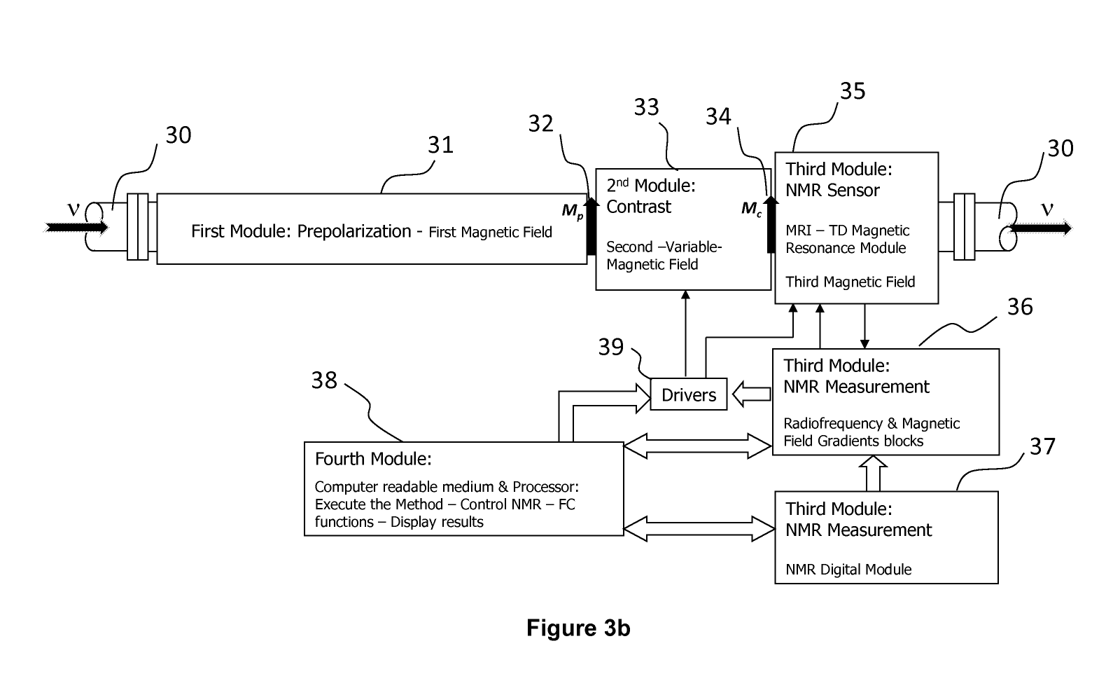

A general schematic representation of a Field Cycling Magnetic Resonance multiphase flow meter/analyzer 200 is illustrated in FIG. 3a. The basic function principle is in accordance with the schematic representation illustrated in FIG. 1. Multiphasic Fluid enters to the Flow Meter through a pipe 30 with velocity. During the passage, multiphasic fluid NMR-active spins sense a plurality of magnetic field zones, each one define a module of Field Cycling Magnetic Resonance Flow Meter/Analyzer apparatus: i) Polarization 26; ii) Relaxation to Contrast 27; iii) NMR data matrix measurement 28 and iv) Data Analysis, Apparatus Automatics and Results Display 29. A plurality of contrast-detection magnetic field devices can be added downstream, in a further preferred embodiment; namely, for example, 27i (i=1 to n) and 28i (i=1 to n). In accordance with a particular experiment, people in the skilled art can decide if spoiler gradients (not illustrated in FIG. 3a) should, or not, be put in.

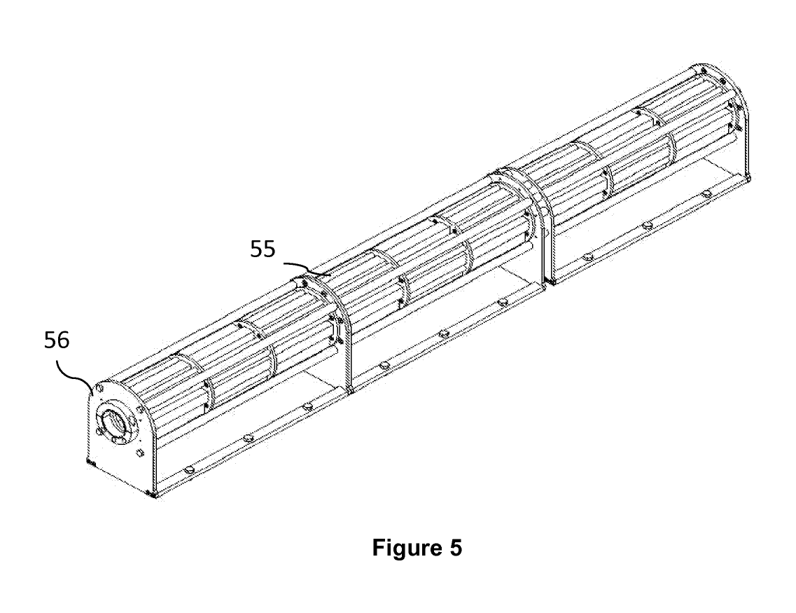

The first preferred exemplary embodiment apparatus and method includes:
1. a first polarization module 26, wherein a set of magnets and flowing paths are configured to polarize the NMR-sensible nuclei belonging to molecules of the total of the phases of the multiphasic fluid until a certain degree of polarizations. At the polarization module 26, the whole set of NMR-active spins are polarized by passing multiphasic fluid through a first magnetic field region. During the passage, nuclear spins belonging to molecules of individual phases in the multiphasic fluid, reach different degrees of polarization, represented by the magnetization Mₚ. As exemplary sub-embodiments of the polarization module, the different polarization degrees can be reached through here disclosed preferred exemplary sub-embodiments, wherein: Said multiphasic fluid reaches full polarization at the downstream end of the polarization module 26; Mₒₚ represents that maximum value characterizes a first exemplary sub-embodiment. The geometric design of the polarization module is fitted in a way that the passage time of the complete set of the phases composing the multiphasic fluid, is regulated to be longer than at least five times the longest spin-lattice relaxation time of individual molecules forming the multiphasic fluid. A preferred exemplary sub-embodiment is illustrated in FIG. 5, where the multiphasic fluid flows through a concentric stainless steel pipe inside a Halbach design permanent magnet (as disclosed by, K. Halbach “Strong Rare Earth Quadrupoles”, IEEE Trans. Nucl. Sci., vol. NS-26, No. 3, June 1979). Magnets bars preferably build the steady magnet (as disclosed by H. Raich and P. Blumler “Design and Construction of a Dipolar Halbach Array With a Homogeneous Field from Identical Bar Magnets; NMR Mandhalas” Concepts Magn. Reson. Part B (Magn Reson Eng.), 23B (2004) 16. At the downstream end of the pre-polarization element, individual magnetizations of each phase composing the multiphasic fluid are, respectively, weighted by their respective Hidrogen Index is the ratio of the hydrogen content, expressed in terms of grams per cubic centimeter, of any material or mixture compared to the hydrogen content of water at s.t.p., (as disclosed by D. V. Ellis and J. M. Singer, “Well Logging for Earth Scientists”, pp. 335, 2^{nd} Ed., Springer 2008, ISBN 978-1-4020-4602-5 (e-book)). A second exemplary sub-embodiment, characterized by that the multiphasic fluid reaches partial polarization at the downstream end of the polarization module 26 by fitting the longitude of the polarization module below the necessary to reach a full polarization of all phases, in a gives fluid velocity range. Calibration surface, including fluid viscosity, pressure and temperature should be obtained in a multiphasic flow loop, and data accumulated in the fourth module of the Field Cycling NMR Flow Meter for posterior normalization of results.

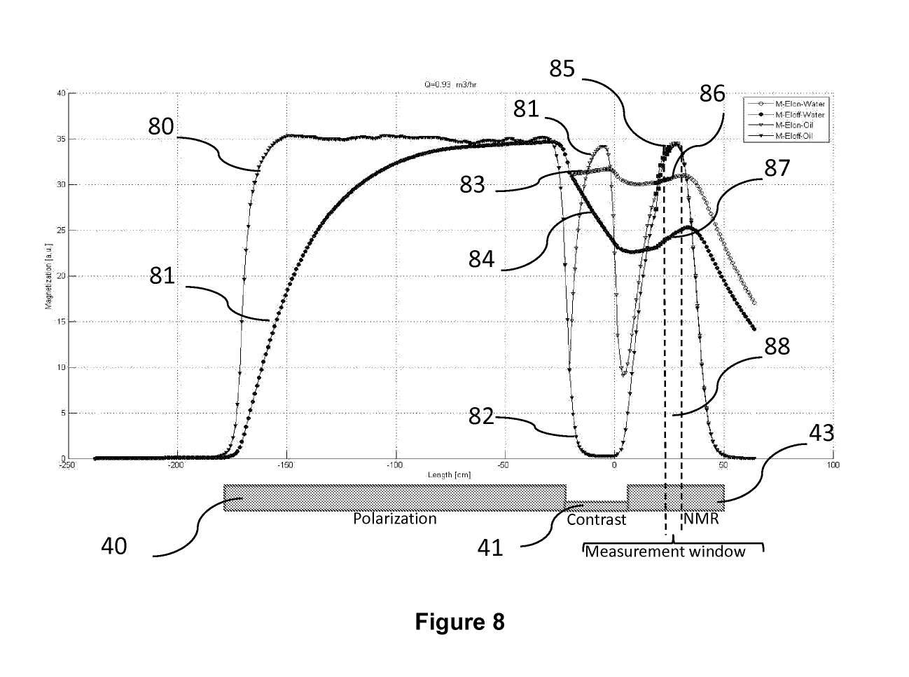

An exemplary disclose of the evolution of the proton magnetization calculated for two components multiphasic fluid (brine and light oil) is illustrated in FIG. 8. T₁( )-profiles were acquired from FIG. 2 data, and flow rate is fixed at 0.93 m³/h. Polarization magnet length is 170 cm, and magnetic field intensity is 300 mT 40. Oil magnetization 80 saturate after flowing through the pipe into the polarization magnetic field approximately 30 cm; while, brine 81 needs to run practically the full length.
2. A second—contrast—module 27, wherein the multiphasic fluid flows into a time- and strength-variable second magnetic field region, wherein the contrast between phase magnetizations is emphasized by the action of the low-Larmor frequency spin-relaxation mechanisms, represented by T₁( ), and illustrated in FIG. 2. The multiphasic fluid magnetizations, provided by nuclei of molecules of the phases mixture of the multiphasic fluid, are weighted by a plurality of strengths of the relaxation second magnetic fields. A plurality of independently phases-contrast degrees is encoded at downstream end of the contrast module. FIG. 8 illustrate on the evolution of the proton magnetization evolution of, respectively, brine and light oil inside the relaxation magnet 41; with a length of 30 cm, and variable magnetic field intensity 41 between 1 to 200 mT. Oil magnetization 80 saturate after flowing through the pipe from upstream split in two: 1) reaching practically zero value 83 when magnetic field is settled to 1 mT; and ii) when contrast module magnetic field is settled at 200 mT, evolution 82, after a sudden decay, recovers at the downstream end of the contrast module 41. Water magnetization 81 of brine also split in two: i) when contrast module magnetic field 41 is settled on (200 mT), just a relatively small decay 85 is observed; and ii) that decay is further pronounced 84 when variable magnetic field 41 is settled to the lowest intensity.
3. A third NMR measurement module 28, wherein the multiphasic fluid flows into a excitation/detection/spatial encoding region, wherein pulsed radiofrequency transmitter/receiving and tridimensional magnetic field gradients are configured to obtain contrasted NMR-signals from protons of molecules forming the phases of the multiphasic-fluid. Within the third module, proton-spins of the multiphasic fluid are subjected to radiofrequency and magnetic gradient fields in steady state or in pulsed sequences designed ad-hoc for each measurement. In response to the NMR excitations/detection/encoding procedures, the contrasted phases cut and velocity profiles are digitally-encoded in a multidimensional data matrix. In NMR-measurement module, the polarization degrees can be reached through different preferred exemplary sub-embodiments, wherein:
   3.1. in a first exemplary sub-embodiment of the NMR measurement module 28, the data matrix elements are recorded in the Fourier domain;
   3.2. in a second exemplary sub-embodiment of the NMR measurement module 28, the data matrix elements are recorded in the Time—Laplace—Domain;
   3.3. in a third exemplary sub-embodiment of the NMR measurement module 28, the data matrix elements are, in addition, spin density spatially encoded and spin velocity encoded at several degrees of contrasts between phases of the multiphasic fluid, following procedures of Magnetic Resonance Imaging in the Fourier domain.
   3.4. in a fourth exemplary sub-embodiment of the NMR measurement module 28, the data matrix elements are, in addition, spin density spatially encoded and spin velocity encoded at several degrees of contrasts between phases composing the multiphasic fluid, following procedures of Magnetic Resonance Imaging in the rotating frame domain.
   3.5. in a fifth exemplary sub-embodiment of the NMR measurement module 28, the data matrix elements are, in addition, spin density spatially encoded and spin velocity encoded at several degrees of contrasts between phases composing the multiphasic phases, following combined procedures of the Magnetic Resonance in, respectively, the Fourier and the Laplace domains. We proceed now to the analysis of the evolution of the contrasted proton magnetization of, respectively, brine and light oil flowing inside the exemplary NMR sensor module magnet 43 as illustrated in FIG. 8. The steady magnetic field, for in-field application preferably permanent, has a length of 60 cm and an intensity of 300 mT. Oil magnetizations 82 and 83 recover after flowing through the pipe containing the NMR sensor module antenna; reaching the value represented by 87. Brine magnetization with contrast magnetic field on to 200 mT goes to the value represented by 86, which is smaller than the one of oil 87; while the counterpart 88, which was contrasted at the lowest relaxation field cannot reach the same degree of recovering. So, in the measurement window 89, signals acquired just within these particular experimental conditions are very similar for oil and rather different for brine. All situations, of course, should be tested in a multiphasic flow loop, giving a multidimensional calibration surfaces that must be accumulated in the fourth module 29.
4. A processor module 29 configured to evaluate flow rates and flow regime of a multiphasic complex fluid, while the multiphasic fluid is flowing through a vein having arbitrary geometry and mixture states. The module also controls the Field Cycling Flow Meter function in automatic running mode, and calculates and display results, as well.

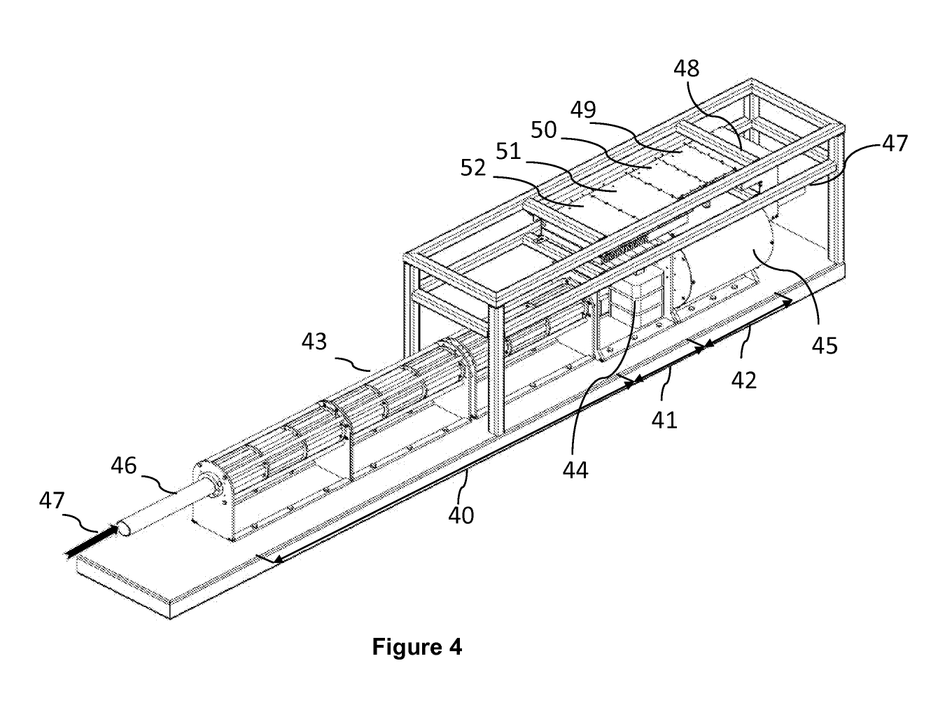

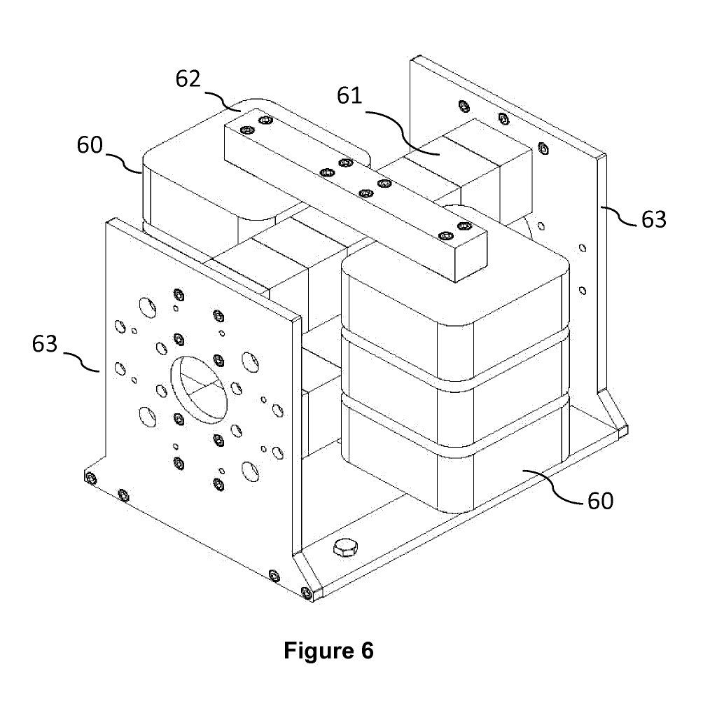

A second preferred embodiment of an exemplary apparatus and method of the present invention is a Proton Field Cycling NMR Multiphasic Flow Meter to measure flow rates in a tri-phasic fluid: oil, gas and water. The exemplary apparatus is illustrated in the FIG. 4 and includes the following method and elements:
1. Fully polarize the NMR-active nuclei in the first pre-polarizing module 43, having a total longitude L 40. The multiphasic fluid flows with mean velocity 47 through a non-ferrous pipe 46, staying into the module at least five times the maximum spin-lattice relaxation time T₁(ₚ)^{max} of the phases. Magnetization at the lowstream end of the pre-polarizing module is the sums of individual cuts time the respective hydrogen index. FIG. 5 illustrates a preferred embodiment of a steady-permanent-Mandhalas Halbach design polarization magnet in detail. The magnet is built from magnetic bars 55 assembled with a metallic structure. Person skill on the art can calculate, design and built the embodiment.
2. Select a first strength of the second relaxation magnetic field and pass the pre-polarized fluid through the second module 41. Respective magnetization characterizing oil, water and gas at the upstream end of the second module relaxes at the downstream end of the second module, to partial magnetizations of oil, water and gas with different rates. Each of the rates is characterized by a relaxation rate gives by the inverse of the spin-lattice relaxation time as measured in the phase, at the corresponding second magnetic field strength. A preferred embodiment 44 of the embodiment is an electromagnet shown in the FIG. 6. A metallic structure 63 contains two coils 60, wired in an iron yoke 62. Iron polar faces 61 distribute magnetic lines in approximately 30 cm of the pipe 46 longitude.
3. Measure the first signal intensity, wherein cuts of phases are encoded.
4. Measure repeatedly the evolution with time of the first signal intensity, wherein phases average velocities are encoded; for instance following the one disclosed by T. M. Osan, “Fast measurements of average flow velocity by Low-Field 1H NMR”, Journal of Magnetic Resonance 209 (2011) 116-122.
5. Wait the period of passage of the measured portion of the first volume or apply a spoiler magnetic field gradient pulse.
6. Repeat steps 3 to 5 until, averaging data until reach a reasonable signal to noise ratio.
7. Accumulate a first average velocity and cut measurement for a first degree of contrast, from the NMR signals received from the multiphasic fluid, in response to the first NMR excitations sequence, as the two first elements of the data matrix.
8. Repeat steps 2 to 7, until complete the set of measurements necessary to complete the set of the data matrix.
9. Estimate the phase-velocities and the phase proportions from data matrix, using—if apply—the condition that the total useful volume inside fluid vein is occupied by the multiphasic fluid.
10. Estimate the flow rate of the fluid-phases, using the estimated velocity of the phases and estimated mass fractions of the phases.

FIG. 4 discloses one preferred embodiment of the field cycling NMR apparatus. The at minimum four modules are illustrated: the first 40 that pre-polarizes the fluid; the second 41 is the relaxation section that provides a variable magnetic field from zero to the highest value compatible with the technology art; the last module 42 is the section dedicated to the NMR measurements that includes the spectroscopic, relaxometry, diffusometry and MRI capabilities. Fluid passes through the apparatus by means of the pipe 46, following the direction specified by arrows 47. As an example, a Halbach permanent magnet configuration 43 has been selected for the pre-polarization magnet of the present preferred embodiment (FIG. 5). This magnet produces a magnetic field, which is perpendicular to the flow direction 47. Such magnetic field can be rotated in any angle with respect to the field direction of the relaxation 44 and NMR modules magnets 45. In the same way, in the present preferred embodiment, the relaxation magnet 44 produces a rotatable magnetic field also perpendicular to the flow direction (FIG. 6). A relaxation magnetic field parallel to the flow direction 47 can be implemented. The NMR module 45 is in this preferred embodiment, composed by a conventional Halbach configuration permanent magnet and a plurality of coils designed to generate the RF pulses and magnetic field gradients as required by spectroscopic, relaxometry, diffusometry and MRI experiments (FIG. 8). An auto-tuning unit, a merit factor compensation 48, a receiver 49, a transmitter 50, a digital console 51 containing a RF signal generation device, a pulse sequence generator, a digital signal acquisition unit, together with the pulsed gradient system 52 compose the electronic hardware of the invention.

In the previous and also following embodiments, the separation space between pre-polarization, relaxation and NMR sensor magnets, is calculated to fulfill both the adiabatic magnetization/demagnetization condition and the magnetization strength losses by spin-lattice relaxation in the whole range of the fluid velocities. In all the embodiments, it is also possible to select the angle between the directions of the relaxation and NMR sensor magnetic field. In this way it is possible to reduce the influences of any variation in the strength of the relaxation magnet on the line width and spectral position of the NMR signal. In particular, perpendicularity between relaxation and sensor fields is another preferred selection for this embodiment.

FIG. 5 illustrates on a preferred embodiment of the pre-polarization magnet. Rectangular section aluminum pipes filled with magnetized standard size SmCo permanent magnetic pieces 55 compose the Halbach-MANDHALAS configuration (see H. Raich, P. Blümler, Design and construction of a dipolar Halbach Array with a Homogeneous Field from Identical Bar Magnets: NMR Mandhalas, Concepts in Magnetic Resonance, 23B (2004) 16-25). The length of those pipes is calculated so that the fluid having the longest T₁-relaxation time remains at least five times T₁ in the interior of the pre-polarization magnet, at the maximum flow velocity.

FIG. 6 illustrates a preferred embodiment of the relaxation module magnet. Two coils 60 provide an electromagnetic field that is conduit to the polar faces 61 by the choke 62. The set can be rotated to any direction perpendicular to the flow field directions. Another preferred embodiment for the relaxation field module, not illustrated in the figure, is a solenoidal coil generating a relaxation magnetic field that is parallel to the flow direction. In the previous and following embodiments the current driving the relaxation magnetic field can be steady, pulsed, or AC.

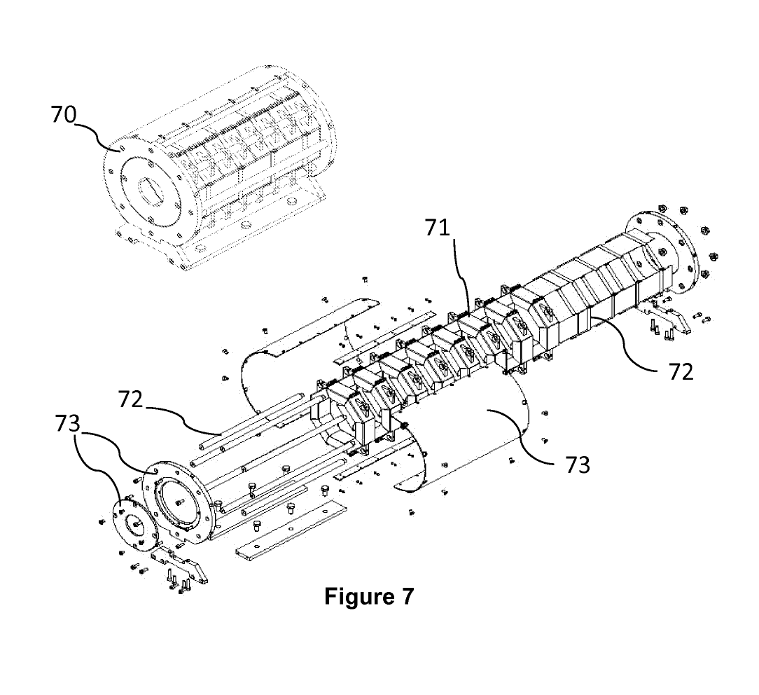

One preferred embodiment for the NMR sensor main magnet is illustrated in the FIG. 7. The set 70 is composed by a plurality of trapezoidal SmCo permanent magnets 71, located following the Halbach-design. Individual trapezoid are thermalized by means of individual cartridges at a temperature higher that the environmental one. The whole set of magnetic and thermal parts are assembles by means of stainless steel bars 72 and the magnetic shield 73. An additional coil system, not illustrated in FIG. 7, which provides a uniform magnetic field, parallel to Bo, is added. That coil system is located concentric to the RF coil. The current circulating through the oil is adjusted in a way to compensate temperature drifts of the main magnetic field Bo.

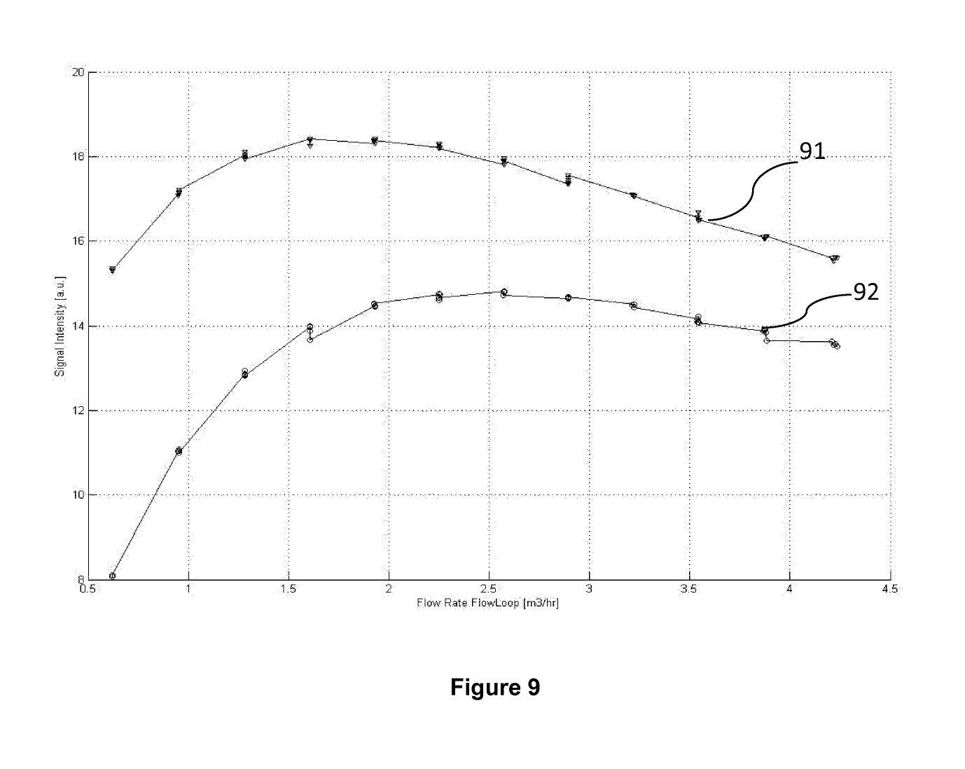

FIG. 9 illustrate on NMR signal intensity behavior for brine in the range of flow rate from 0.6 to 4.2 m³/h, measured with the Field Cycling Magnetic Resonance prototype illustrated in FIG. 4. Experimental behavior 91 correspond to the NMR signal magnitude for the brine sample when the second magnetic field intensity in the second magnetic field region is fixed in 300 mT. Experimental behavior 92 correspond to the NMR signal magnitude for the same brine sample when the second magnetic field intensity in the second magnetic field region is fixed in 0 mT. Contrast between both NMR signal magnitudes are clearly shown.

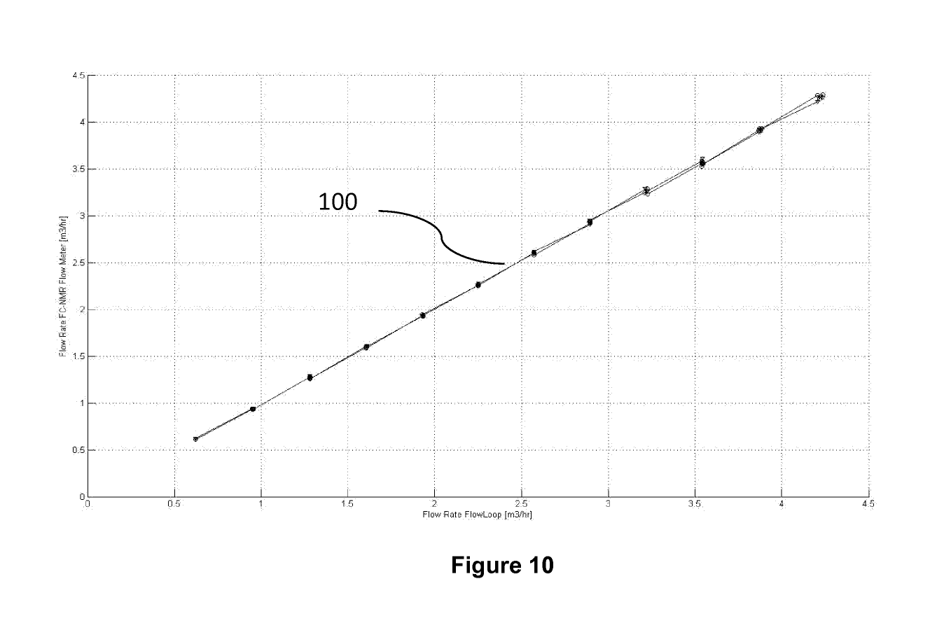

FIG. 10 illustrate flow rate measured in a multiphasic flow loop, with the Field Cycling Magnetic Resonance prototype illustrated in FIG. 4, in comparison with the simultaneous measurements with conventional Coriolis flow meter. Behaviors of flow rates 100 setting are just the same brine sample when the second magnetic field intensity in the second magnetic field region is respectively fixed at 0 mT and 300 mT.

Where it is declared or described that an apparatus of this invention includes, contains, has, is compound or is constituted by certain components, it must be understood, except when this declaration or description expresses the contrary, that one or more explicitly described components can be present in the apparatus. In an alternative embodiment, nevertheless, the apparatus of this invention can essentially be declared or described as consisting of certain components, in which the components of this embodiment which could materially alter the operation principle or the differentiating characteristics of the apparatus could not be present in the declaration or the description of this alternative embodiment. In another alternative embodiment, the apparatus of this invention can be declared or described as consisting of certain components, in which other components of the embodiment could not be declared or described.

Where the article “a” is used in a declaration of or in a description of the presence of a component in the apparatus of this invention, it must be understood, unless this declaration or description expresses explicitly the contrary, that the use of the indefinite article does not limit the presence of the component in the apparatus to one in number.

An example NMR flow meter/analyzer 100 is shown in FIGS. 2-10 to illustrate NMR Field Cycling instrumentation techniques and apparatus improvements that alone and/or in combination can improve, reduce costs, and make NMR instrumentation and analytical capabilities more available, convenient, and cost effective for a variety of fluid applications. Therefore, while most of the description herein utilizes the example flow meter 100 as a convenient vehicle to explain the features, apparatus, and methods claimed herein, these features, apparatus, and methods are not intended to be limited to this example or to only flow meters or flow controllers. On the contrary, NMR signal generation and detection using any one or more of the features or processes described herein are useful for myriad other NMR instrumentation and analytical applications as well. Also, the illustrations in the drawings are not drawn to illustrate any particular sizes or proportions, and while some such sizes or proportions may be exaggerated or distorted for practicality, persons skilled in the art will understand the information illustrated.

Where it is declared or described that an apparatus of this invention includes, contains, has, is compound by or is constituted by certain components, it must be understood, except when this declaration or description expresses the contrary, that one or more explicitly described components can be present in the apparatus. In an alternative embodiment, nevertheless, the apparatus of this invention can essentially be declared or described as consisting of certain components, in which the components of this embodiment which could materially alter the operation principle or the differentiating characteristics of the apparatus could not be present in the declaration or the description of this alternative embodiment. In another alternative embodiment, the apparatus of this invention can be declared or described as consisting of certain components, in which other components of the embodiment could not be declared or described.

The words “comprise,” ‘comprises,” “comprising,” “composed,” “composes”, “composing,” “include,” “including,” and “includes” when used in this specification, including the claims, are intended to specify the presence of state features, integers, components, or steps, but they do not preclude the presence or addition of one or more other features, integers, components, steps, or groups thereof. Also the words “maximize” and “minimize” as used herein include increasing toward or approaching a maximum and reducing toward or approaching a minimum, respectively, even if not all the way to an absolute possible maximum or to an absolute possible minimum. The term “insignificant” means not enough to make a difference in practical applications, unless the context indicates otherwise. Also, the measurements described can be repeated any number of times by allowing enough time between measurements for the fluid affected by the RF field to clear out of the coil volume 81 and then performing the measurements again. Multiple measurements can be used, if desired, to determine flow rate or rates, average flow rates, statistical flow rates, etc. Also, while the methods described above referred to NMR measurements utilizing the spins or nuclear magnetic moments of hydrogen, these NMR measurements can also be made with nuclear magnetic moments of fluorine, chlorine, and other materials.

The invention claimed is:

1) A Field Cycling Magnetic Resonance method to measure and analyze flow properties in flowing multiphasic complex fluids, comprising:
a. polarizing a plurality of NMR active spins of a multiphasic complex fluid using a first magnetic field region, wherein the multiphasic complex fluid is composed by a plurality of phases, wherein the multiphasic complex fluid is herein flowing through the first magnetic field region, therefore creating a total macroscopic magnetization of the multiphasic complex fluid, wherein the total macroscopic magnetization is the result of adding all the individual macroscopic magnetizations, each corresponding to the different phases of the multiphasic complex fluid;
b. relaxing the plurality of individual macroscopic magnetizations of the phases of the multiphasic complex fluid in a second magnetic field region, wherein the second magnetic field region is variable in intensity and permits applying a plurality of magnetic field intensities over time, wherein the plurality of magnetic field intensities of the second magnetic field region is applied to the multiphasic complex fluid, wherein the multiphasic complex fluid is herein flowing through the second magnetic field region, the second magnetic field region having a downstream end, wherein each individual macroscopic magnetization of each phase of the multiphasic complex fluid relaxes with different relaxation rates for each magnetic field intensity of the second magnetic field region, wherein applying the plurality of magnetic field intensities produce that the individual macroscopic magnetization of each phase of the multiphasic complex fluid at the downstream end of the second magnetic field region is different for each magnetic field intensity of the second magnetic field region, therefore applying the plurality of magnetic field intensities of the second magnetic field region will encode an individual magnetization value for each of the phases in the total macroscopic magnetization for each of the magnetic field intensity applied;
c. measuring the total macroscopic magnetization and fluid velocity for each of the magnetic field intensities applied in a third magnetic field region, wherein the third magnetic field region comprises an NMR measurement module, wherein the NMR measurement module permits measuring a plurality of magnetic resonance experimental parameters, wherein the NMR measurement module is capable of acquiring a plurality of NMR signals corresponding to the NMR active spins of the multiphasic complex fluid, therefore multiphasic flow properties, field cycling magnetic field weighted relaxation profile and diffusion profile, are acquired and stored in a multidimensional data matrix;
d. reading the multidimensional data matrix with a tangible computer-readable medium having stored thereon instructions that when read by a processor enable the processor to execute a method to evaluate multiphasic flow properties, field cycling magnetic field weighted relaxation profile and diffusion profile.

2) The method according to claim 1, wherein the method of step (d) further comprises evaluating the data matrix in accordance with spin relaxation properties of each one of the phases composing the multiphasic complex fluid, evaluating geometrical design of arrangement of magnets, antennas and fluid paths, evaluating a set of calibration matrix; evaluating excitation, encoding and detection procedures, evaluating a set of independent equations fitting coefficients relating to the data matrix, the data matrix comprising individual phases flow-rate.

3) The method according to claim 2, wherein the method of step (d) of claim 1 further comprises, evaluating profile of liquid levels in the pipe.

4) The method according to claim 2, wherein the method of step (d) of claim 1 further comprises, evaluating in-pipe localized viscosity measurements.

5) The method according to claim 2, wherein the method of step (d) of claim 1 further comprises, in-pipe density profile of fluids.

6) The method according to claim 2, wherein the method of step (d) of claim 1 further comprises size distribution of solid particles.

7) A Field Cycling Magnetic Resonance based apparatus to measure and analyze flow properties in flowing multiphasic complex fluids, comprising:
a first magnet module, wherein the magnet module having an upstream end and a downstream end, the first module comprising a first magnet, wherein the first magnet creates a first magnetic field region with a constant magnetic field intensity, wherein the multiphasic complex fluid flows through the first magnetic field region, and wherein in the first magnetic field region a plurality of NMR active spins of the multiphasic complex fluid are polarized;
a second magnet module having an upstream end and a downstream end, the second module comprising a second magnet, wherein the upstream end of the second segment is adjacently connected to the downstream end of the first module so the multiphasic complex fluid flows to the second magnet module, wherein the second magnet creates a second magnetic field region, wherein the second magnetic field region is variable in magnetic field intensity and time, and wherein the fluid passes through the variable magnetic field region, and wherein in the variable magnetic field region a plurality of spins of the multiphasic complex fluid relax;
an third module, having an upstream end and a downstream end, the third module comprising a third magnet, a plurality of radio-frequency antennas and a plurality of magnetic field gradient coils, wherein the upstream end of the third segment is adjacently connected to the downstream end of the second segment; wherein the third magnet creates a third magnetic field region with a constant magnetic field intensity, wherein the fluid passes through the third magnetic field region, wherein the radio-frequency antennas create an electromagnetic excitation field applying a plurality of radio frequency pulses, wherein the fluid passes through the electromagnetic excitation field, and wherein the radio-frequency antenna receives a magnetic resonance signal response originated in the multiphasic complex fluid; wherein the magnetic field gradient coils create a plurality of variable local magnetic fields, wherein the fluid passes through the plurality of variable local magnetic fields, wherein the plurality of spins of the multiphasic complex fluid are spatially encoded;
a fourth module, the fourth module comprising a computing digital processor, configured to read a tangible computer-readable medium having stored thereon instructions that when read by a processor enable the processor to execute said method, control NMR Field Cycling apparatus elements to execute automatic experimental measurements and display experimental results.

8) The apparatus of claim 7, wherein the second magnet is an electromagnet capable of creating different magnetic field intensities.

9) The apparatus of claim 7, wherein the first magnet module has a size that is large enough so the passage time of the multiphasic complex fluid through the first magnet module is longer than five times the longest spin-lattice relaxation time of the NMR active spins forming the multiphasic complex fluid, wherein at the downstream end of the first magnet module the NMR active spins of each phase composing said multiphasic complex fluid are, respectively, weighted by their respective Hydrogen Index.
